(19) United States
(12) Patent Application Publication
(10) Pub. No.: US 2023/0407973 A1
(43) Pub. Date: Dec. 21, 2023

(54) PADDLE VALVE AND HOUSING THEREFOR

(71) Applicant: Allegheny Valve & Coupling, Inc., Warren, PA (US)

(72) Inventor: Raymond V. Heelan, JR., Warren, PA (US)

(21) Appl. No.: 17/748,283

(22) Filed: May 19, 2022

(51) Int. Cl. F16K 1/22; F16K 1/226; F16K 31/60; F16K 35/02

(52) U.S. Cl. CPC F16K 1/221; F16K 35/027; F16K 31/602; F16K 1/2261

(57) ABSTRACT

A paddle valve assembly includes a valve body having a cylindrical passage defined therein, a paddle member having a seal disposed about an entire circumference thereof, and a drive shaft and an idler shaft that rotatably connect the paddle member to the valve body. The paddle member is rotatable within the cylindrical passage about a rotation axis between open and closed positions. The drive shaft and the idler shaft are disposed in the valve body in line with each other along the rotation axis of the paddle member and are received in offset pockets defined in the paddle member. The paddle member extends at an angle with respect to the longitudinal axis of the cylindrical passage when in the closed position. The sealing engagement between the seal and the cylindrical passage of the valve body is continuous about the entire circumference of the paddle member.

### BACKGROUND

### Technical Field

The present disclosure relates generally to valves and valving arrangements for interacting with various components of a material transfer or handling system, such as a pipeline in a loading or unloading application and, in particular, to a paddle valve arrangement that allows for quick opening, quick closure, and more efficient sealing of a paddle member within the valve.

### Technical Considerations

Valves are used in a variety of applications and systems that require the prevention, redirection, or manipulation of various product and material streams, whether solid, semi-solid, or fluid materials. As is known in the art, these materials flow through the material handling system, such as in pipelines and the like, in order to transfer the materials from location to location. In order to manage the direction, flow, and other characteristics of the material transfer process, valve arrangements are utilized. For example, such valve arrangements may include gate valves, manifold valves, butterfly valves, flapper valves, etc.

Conventional butterfly or paddle valves customarily include a rotatable valve element, such as a disc, which includes a seal. The valve element is mounted within a fluid passage defined within a conduit or pipeline. The valve element, in a closed position, is arranged substantially perpendicular to a housing. The seal should provide an effective seal around the periphery of the valve element while still allowing the valve element to easily rotate between open and closed positions. In conventional butterfly or paddle valve assemblies, the construction of the rotation shaft for rotating the valve element interferes with effective sealing of the valve element within the fluid passage. Solutions to ensure sealing around the periphery of the valve element require complicated and expensive constructions of both the valve member and the valve body and may interfere with efficient opening and closing of the valve member.

### SUMMARY

Therefore, in some non-limiting embodiments or aspects, an improved paddle valve and housing therefore have been devised.

In accordance with some non-limiting embodiments or aspects of the present disclosure, provided is a paddle valve assembly that may include a valve body having an elliptical passage extending along a longitudinal axis, a paddle member rotatably disposed in the elliptical passage of the valve body, and a drive shaft rotatably connecting the paddle member to the valve body. The paddle member may be rotatable within the elliptical passage about a rotation axis between an open position in which the paddle member allows flow through the elliptical passage and a closed position in which the paddle member blocks flow through the elliptical passage. The rotation axis of the paddle member may be perpendicular to the longitudinal axis of the valve body. In the closed position, the paddle member may be inclined relative to the elliptical passage at a non-perpendicular angle relative to the longitudinal axis of the valve body.

In accordance with some non-limiting embodiments or aspects of the present disclosure, the paddle member may include a seal disposed about an entire circumference thereof. The seal may form a sealing engagement with the elliptical passage in the closed position of the paddle member. The sealing engagement between the seal and the elliptical passage may be continuous about the entire circumference of the paddle member. The seal may be disposed within a groove defined in a circumferential surface of the paddle member. The seal may have a circular or non-circular cross-sectional shape.

In accordance with some non-limiting embodiments or aspects of the present disclosure, the paddle member may have a circular or an elliptical shape. The paddle member may be configured to rotate 90° between the open position and the closed position.

In accordance with some non-limiting embodiments or aspects of the present disclosure, the paddle valve assembly further may include an idler shaft disposed in the valve body on an opposite side of the elliptical passage to the drive shaft. The idler shaft may rotatably connect the paddle member to the valve body. The drive shaft and the idler shaft may be disposed in the valve body in line with each other and extend along the rotation axis of the paddle member.

In accordance with some non-limiting embodiments or aspects of the present disclosure, the paddle member further may include a first shaft pocket and a second shaft pocket. The drive shaft may be received in the first shaft pocket and the idler shaft may be received in the second shaft pocket. The first shaft pocket and the second shaft pocket may be offset with respect to each other. The first shaft pocket and the second shaft pocket may be in line with the rotation axis of the paddle member. The drive shaft and the idler shaft may be disposed in respective apertures defined in the valve body intersecting with the elliptical passage, wherein the drive shaft and the idler shaft have respective offset portions configured to be received within the first shaft pocket and the second shaft pocket of the paddle member, and wherein the drive shaft and the idler shaft each include at least one seal disposed thereon configured to seal an engagement between the shaft and the valve body.

In accordance with some non-limiting embodiments or aspects of the present disclosure, the paddle valve assembly may include an actuating member operatively connected to the drive shaft. The actuating member may be configured to be operated to move the paddle member between the open position and the closed position. The actuating member may include a handle connected to the drive shaft and a metering plate configured for selectively locking a position of the handle at one of a plurality of positions between a first position and a second position corresponding to the open position and the closed position of the paddle member.

In accordance with some non-limiting embodiments or aspects of the present disclosure, a paddle valve assembly may include a valve body having an elliptical passage, the elliptical passage extending along a longitudinal axis. The paddle valve assembly further may include a paddle member rotatably disposed in the elliptical passage of the valve body, wherein the paddle member has a circular or an elliptical shape. The paddle valve assembly further may include a seal disposed about an entire circumference thereof, a drive shaft rotatably connecting the paddle member to the valve body, and an actuating member operatively connected to the drive shaft. The paddle member may be rotatable via the actuating member within the elliptical passage about a rotation axis between an open position in which the paddle member allows flow through the elliptical passage and a closed position in which the paddle member blocks flow through the elliptical passage and the seal forms a sealing engagement with the elliptical passage in the closed position of the paddle member. The rotation axis of the paddle member may be perpendicular to the longitudinal axis of the valve body. In the closed position, the paddle member may be inclined relative to the elliptical passage at a non-perpendicular angle relative to the longitudinal axis of the valve body.

In accordance with some non-limiting embodiments or aspects of the present disclosure, the seal may be disposed within a groove defined in a circumferential surface of the paddle member. The seal may have a circular or a non-circular cross-sectional shape.

In accordance with some non-limiting embodiments or aspects of the present disclosure, the paddle valve assembly further may include an idler shaft disposed in the valve body on an opposite side of the elliptical passage to the drive shaft. The idler shaft may rotatably connect the paddle member to the valve body.

In accordance with some non-limiting embodiments or aspects of the present disclosure, the actuating member may include a handle connected to the drive shaft and a metering plate configured for selectively locking a position of the handle at one of a plurality of positions between a first position and a second position corresponding to the open position and the closed position of the paddle member.

In accordance with some non-limiting embodiments or aspects of the present disclosure, a paddle valve assembly may include a valve body having an elliptical passage, the elliptical passage extending along a longitudinal axis. The paddle valve assembly further may include an elliptical paddle member rotatably disposed in the elliptical passage of the valve body, the elliptical paddle member having a seal disposed about an entire circumference thereof, a first shaft pocket, and a second shaft pocket. The paddle valve assembly further may include a drive shaft and an idler shaft disposed in the valve body on opposite sides of the elliptical passage, the drive shaft and the idler shaft rotatably connecting the elliptical paddle member to the valve body. The drive shaft may be received in the first shaft pocket of the elliptical paddle member and the idler shaft may be received in the second shaft pocket of the elliptical paddle member. The elliptical paddle member may be rotatable within the elliptical passage about a rotation axis between an open position in which the elliptical paddle member allows flow through the elliptical passage and a closed position in which the elliptical paddle member blocks flow through the elliptical passage and the seal forms a sealing engagement with the elliptical passage of the valve body. The rotation axis of the elliptical paddle member may be perpendicular to the longitudinal axis of the valve body. The drive shaft and the idler shaft may be disposed in the valve body in line with each other and extend along the rotation axis of the elliptical paddle member. The first shaft pocket and the second shaft pocket of the elliptical paddle member may be offset with respect to each other. The elliptical paddle member may define a normal that extends at an angle with respect to the longitudinal axis of the elliptical passage when the elliptical paddle member is in the closed position. The first shaft pocket and the second shaft pocket may be defined in the elliptical paddle member such that the seal extending about the entire circumference of the elliptical paddle member is uninterrupted and the sealing engagement between the seal and the elliptical passage of the valve body is continuous about the entire circumference of the elliptical paddle member.

Further non-limiting embodiments or aspects of the paddle valve and housing therefor are set forth in the following numbered clauses:

Clause 1. A paddle valve assembly comprising: a valve body having an elliptical passage extending along a longitudinal axis; a paddle member rotatably disposed in the elliptical passage of the valve body; and a drive shaft rotatably connecting the paddle member to the valve body, wherein the paddle member is rotatable within the elliptical passage about a rotation axis between an open position in which the paddle member allows flow through the elliptical passage and a closed position in which the paddle member blocks flow through the elliptical passage, wherein the rotation axis of the paddle member is perpendicular to the longitudinal axis of the valve body, and wherein, in the closed position, the paddle member is inclined relative to the elliptical passage at a non-perpendicular angle relative to the longitudinal axis of the valve body.

Clause 2. The paddle valve assembly according to clause 1, wherein the paddle member comprises a seal disposed about an entire circumference thereof, and wherein the seal forms a sealing engagement with the elliptical passage in the closed position of the paddle member.

Clause 3. The paddle valve assembly according to clause 1 or 2, wherein the sealing engagement between the seal and the elliptical passage is continuous about the entire circumference of the paddle member.

Clause 4. The paddle valve assembly according to any of clauses 1-3, wherein the seal is disposed within a groove defined in a circumferential surface of the paddle member, and wherein the seal has a circular or a non-circular cross-sectional shape.

Clause 5. The paddle valve assembly according to any of clauses 1-4, wherein the paddle member has a circular or an elliptical shape.

Clause 6. The paddle valve assembly according to any of clauses 1-5, wherein the paddle member is configured to rotate 90° between the open position and the closed position.

Clause 7. The paddle valve assembly according to any of clauses 1-6, further comprising an idler shaft disposed in the valve body on an opposite side of the elliptical passage to the drive shaft, the idler shaft rotatably connecting the paddle member to the valve body.

Clause 8. The paddle valve assembly according to any of clauses 1-7, wherein the drive shaft and the idler shaft are disposed in the valve body in line with each other and extend along the rotation axis of the paddle member.

Clause 9. The paddle valve assembly according to any of clauses 1-8, wherein the paddle member further comprises a first shaft pocket and a second shaft pocket.

Clause 10. The paddle valve assembly according to any of clauses 1-9, wherein the drive shaft is received in the first shaft pocket and the idler shaft is received in the second shaft pocket.

Clause 11. The paddle valve assembly according to any of clauses 1-10, wherein the first shaft pocket and the second shaft pocket are offset with respect to each other.

Clause 12. The paddle valve assembly according to any of clauses 1-11, wherein the first shaft pocket and the second shaft pocket are in line with the rotation axis of the paddle member.

Clause 13. The paddle valve assembly according to any of clauses 1-12, wherein the drive shaft and the idler shaft are disposed in respective apertures defined in the valve body intersecting with the elliptical passage, wherein the drive shaft and the idler shaft have respective offset portions configured to be received within the first shaft pocket and the second shaft pocket of the paddle member, wherein the drive shaft and the idler shaft each include at least one seal disposed thereon configured to seal an engagement between the shaft and the valve body.

Clause 14. The paddle valve assembly according to any of clauses 1-13, further comprising an actuating member operatively connected to the drive shaft, the actuating member being configured to be operated to move the paddle member between the open position and the closed position.

Clause 15. The paddle valve assembly according to any of clauses 1-14, wherein the actuating member comprises a handle connected to the drive shaft and a metering plate configured for selectively locking a position of the handle at one of a plurality of positions between a first position and a second position corresponding to the open position and the closed position of the paddle member.

Clause 16. A paddle valve assembly comprising: a valve body having an elliptical passage, the elliptical passage extending along a longitudinal axis; a paddle member rotatably disposed in the elliptical passage of the valve body, wherein the paddle member has a circular or an elliptical shape; a seal disposed about an entire circumference thereof; a drive shaft rotatably connecting the paddle member to the valve body; and an actuating member operatively connected to the drive shaft, wherein the paddle member is rotatable via the actuating member within the elliptical passage about a rotation axis between an open position in which the paddle member allows flow through the elliptical passage and a closed position in which the paddle member blocks flow through the elliptical passage and the seal forms a sealing engagement with the elliptical passage in the closed position of the paddle member, wherein the rotation axis of the paddle member is perpendicular to the longitudinal axis of the valve body, and wherein, in the closed position, the paddle member is inclined relative to the elliptical passage at a non-perpendicular angle relative to the longitudinal axis of the valve body.

Clause 17. The paddle valve assembly according to clause 16, wherein the seal is disposed within a groove defined in a circumferential surface of the paddle member, and wherein the seal has a circular or a non-circular cross-sectional shape.

Clause 18. The paddle valve assembly according to clause 16 or clause 17, further comprising an idler shaft disposed in the valve body on an opposite side of the elliptical passage to the drive shaft, the idler shaft rotatably connecting the paddle member to the valve body.

Clause 19. The paddle valve assembly according to any of clauses 16-18, wherein the actuating member comprises a handle connected to the drive shaft and a metering plate configured for selectively locking a position of the handle at one of a plurality of positions between a first position and a second position corresponding to the open position and the closed position of the paddle member.

Clause 20. A paddle valve assembly, comprising: a valve body having an elliptical passage, the elliptical passage extending along a longitudinal axis; an elliptical paddle member rotatably disposed in the elliptical passage of the valve body, the elliptical paddle member comprising a seal disposed about an entire circumference thereof, a first shaft pocket, and a second shaft pocket; and a drive shaft and an idler shaft disposed in the valve body on opposite sides of the elliptical passage, the drive shaft and the idler shaft rotatably connecting the elliptical paddle member to the valve body, the drive shaft being received in the first shaft pocket of the elliptical paddle member and the idler shaft being received in the second shaft pocket of the elliptical paddle member, wherein the elliptical paddle member is rotatable within the elliptical passage about a rotation axis between an open position in which the elliptical paddle member allows flow through the elliptical passage and a closed position in which the elliptical paddle member blocks flow through the elliptical passage and the seal forms a sealing engagement with the elliptical passage of the valve body, the rotation axis of the elliptical paddle member being perpendicular to the longitudinal axis of the valve body, wherein the drive shaft and the idler shaft are disposed in the valve body in line with each other and extend along the rotation axis of the elliptical paddle member, wherein the first shaft pocket and the second shaft pocket of the elliptical paddle member are offset with respect to each other, wherein the elliptical paddle member defines a normal that extends at an angle with respect to the longitudinal axis of the elliptical passage when the elliptical paddle member is in the closed position, and wherein the first shaft pocket and the second shaft pocket are defined in the elliptical paddle member such that the seal extending about the entire circumference of the elliptical paddle member is uninterrupted and the sealing engagement between the seal and the elliptical passage of the valve body is continuous about the entire circumference of the elliptical paddle member.

These and other features and characteristics of the present disclosure, as well as the methods of operation and functions of the related elements of structures and the combination of parts and economies of manufacture, will become more apparent upon consideration of the following description and with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a perspective view of a paddle valve assembly according to some non-limiting embodiments or aspects of the present disclosure, with the paddle valve shown in an open position;

FIG. 2 is an exploded view of the paddle valve assembly shown in FIG. 1;

FIG. 3 is a front view of the paddle valve assembly of FIG. 1;

FIG. 4 is a side cross-sectional view of the paddle valve assembly of FIG. 3 taken along line A-A;

FIG. 5 is a front view of the paddle valve assembly of FIG. 1;

FIG. 6 is side view of the paddle valve assembly, with the paddle valve in a closed position;

FIG. 7 is a side cross-sectional view of the paddle valve assembly of FIG. 6 taken along line B-B;

FIG. 8 is a front view of the paddle valve assembly of FIG. 6;

FIG. 9 is a side cross-sectional view of the paddle valve assembly of FIG. 8 taken along line C-C;

FIG. 10 is an enlarged view of Detail A shown in FIG. 9; and

FIG. 11 is an enlarged view of Detail B shown in FIG. 9.

### DETAILED DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the embodiments or aspects as shown in the drawing figures and are not to be considered as limiting as the embodiments or aspects can assume various alternative orientations.

All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The word “comprising” and “comprises”, and the like, does not exclude the presence of elements or steps other than those listed in any claim or the specification as a whole. In the present specification, “comprises” means “includes” and “comprising” means “including”.

As used herein, the terms “parallel” or “substantially parallel” mean a relative angle as between two objects (if extended to theoretical intersection), such as elongated objects and including reference lines, that is from 0° to 5° , or from 0° to 3° , or from 0° to 2° , or from 0° to 1° , or from 0° to 0.5° , or from 0° to 0.25° , or from 0° to 0.1° , inclusive of the recited values.

As used herein, the terms “perpendicular”, “transverse”, “substantially perpendicular”, or “substantially transverse” mean a relative angle as between two objects at their real or theoretical intersection is from 85° to 90° , or from 87° to 90° , or from 88° to 90° , or from 89° to 90°, or from 89.5° to 90° , or from 89.75° to 90° , or from 89.9° to 90° , inclusive of the recited values.

The discussion of various embodiments or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various embodiments and aspects described herein.

The disclosure comprises, consists of, or consists essentially of, the following embodiments or aspects, in any combination. Various embodiments or aspects of the disclosure are illustrated in separate drawing figures. However, it is to be understood that this is simply for ease of illustration and discussion. In the practice of the disclosure, one or more embodiments or aspects shown in one drawing figure can be combined with one or more embodiments or aspects shown in one or more of the other drawing figures.

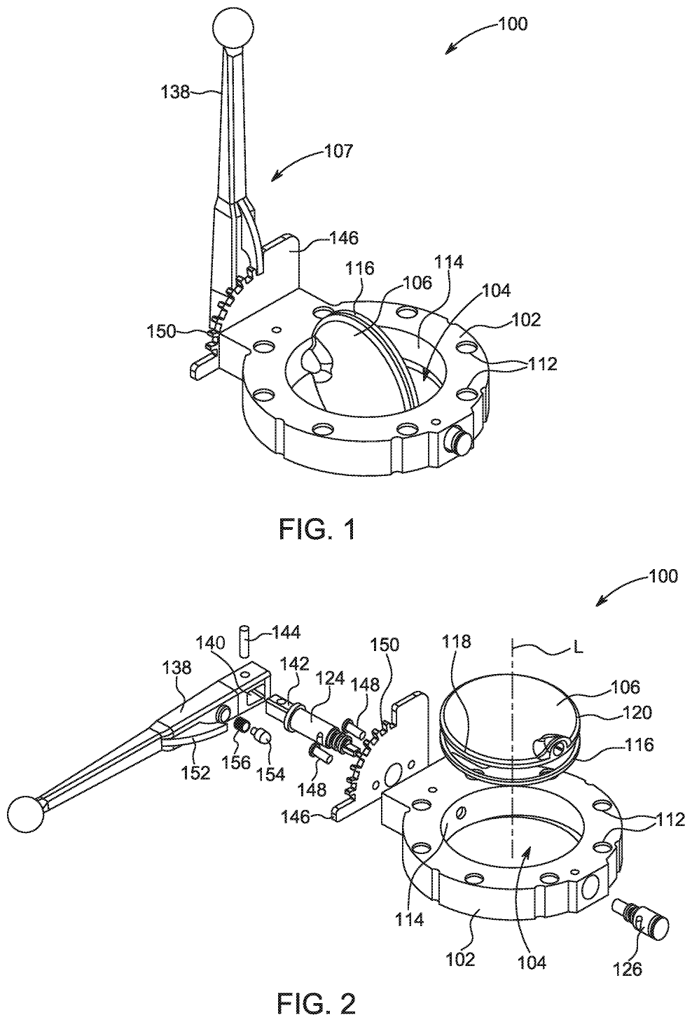

The present disclosure is directed to a paddle or butterfly valve assembly 100 as illustrated in the non-limiting embodiments or aspects shown in FIGS. 1-11. With initial reference to FIG. 1, the paddle valve assembly 100 is configured for use within a piping or conduit system to regulate a flow of a fluid through the system. The paddle valve assembly 100 is operable between a closed position, in which fluid flow through the piping or conduit system is prevented, and an open position, in which fluid flow through the piping or conduit system is permitted. The paddle valve assembly 100 includes a valve body 102 or housing having a passage 104 defined therein, and a paddle member 106 rotatably disposed in the passage 104. The paddle member 106 is movable within the passage 104 between an open position, in which the paddle member 106 allows flow through the passage 104 and a closed position, in which the paddle member 106 blocks flow through the passage 104. The paddle member 106 is operably connected to an actuating member 107 configured for moving the paddle member 106 between the closed position and the open position, as described herein.

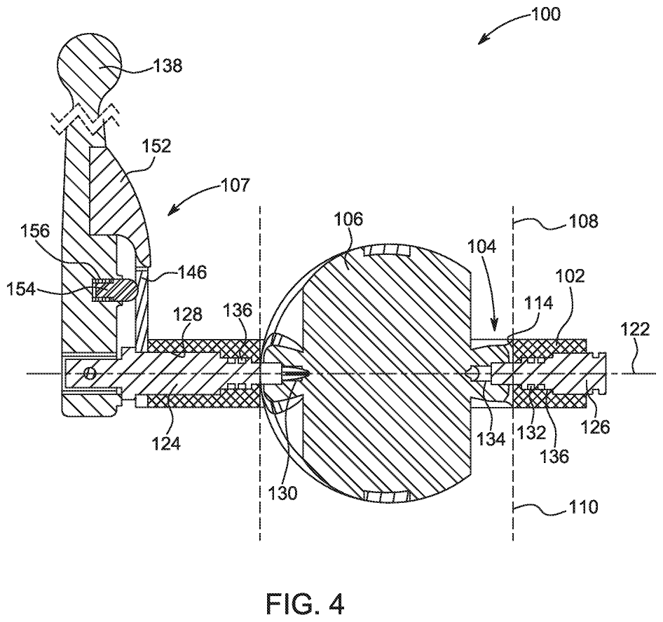

In some non-limiting embodiments or aspects, the piping or conduit system is exemplified by an inlet pipe or conduit 108 and an outlet pipe or conduit 110 shown in FIG. 4. The pipes or conduits 108, 110 are connected to opposing sides of the valve body 102 and are in fluid communication with the passage 104 defined in the valve body 102. In some non-limiting embodiments or aspects, the valve body 102 may have a plurality of through holes 112 configured for receiving a corresponding plurality of fasteners (not shown) for connecting the pipes or conduits 108, 110 to the valve body 102. In other embodiments or aspects, the pipes or conduits 108, 110 may be connected to the valve body 102 via a coupling that engages a flange on each of the pipes or conduits 108, 110. The piping or conduit system may take any form and may be connected to the valve body 102 in any manner found to be suitable to those having ordinary skill in the art.

According to some non-limiting embodiments or aspects of the present disclosure, the valve body 102 is formed as a single, monolithic piece. It is to be appreciated that the valve body 102 may be formed from any construction or shape configuration and with any materials known to be suitable to those having ordinary skill in the art. The passage 104 extends in a direction of a longitudinal axis L (shown in FIG. 2). As shown in FIG. 2, an interior surface 114 of the passage 104 of the valve body 104 extends parallel to the longitudinal axis L.

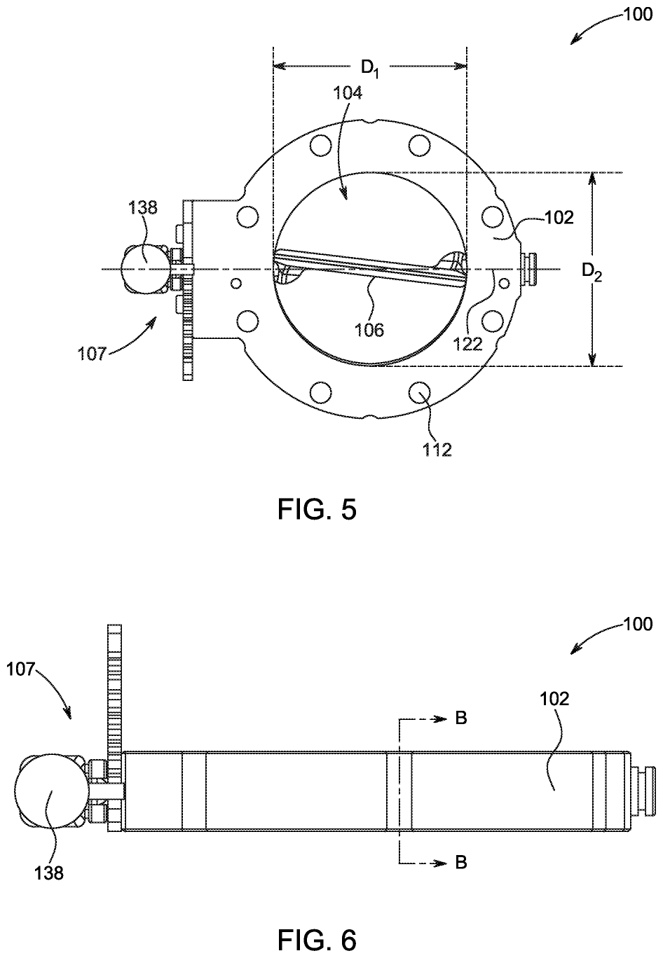

The passage 104 of the valve body 102 may have an elliptical shape. For example, with reference to FIG. 5, the passage 104 may have a major diameter D1 and a minor diameter D2, wherein the major diameter D1 is larger than the minor diameter D2. In some embodiments or aspects, the passage 104 may be circular, wherein the major diameter Dl is equal to the minor diameter D2.

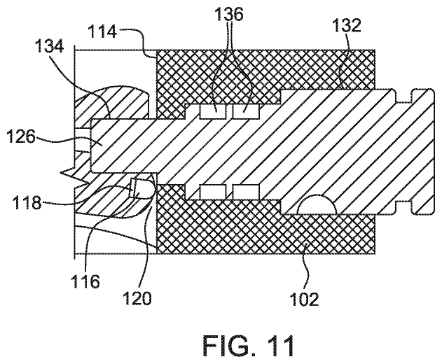

With reference to FIGS. 1-2, the paddle member 106 is rotatably disposed in the passage 104 of the valve body 102. In some non-limiting embodiments or aspects, the paddle member 106 may include a seal 116 disposed about an entire circumference of the paddle member 106. The seal 116 is disposed within a groove 118 defined in a circumferential surface 120 of the paddle member 106. In some embodiments or aspects, the seal 116 may have a D-shaped cross-sectional shape (see FIGS. 10-11). In other embodiments or aspects, the seal 116 may have a circular cross-sectional shape. The seal 116 is configured to form a sealing engagement with the interior surface 114 of the passage 104 in the closed position of the paddle member 106. In some embodiments or aspects, the sealing engagement between the seal 116 and the passage 104 is continuous about the entire circumference of the paddle member 106. The seal 116 may be configured to exert an even pressure on the interior surface 114 when the paddle member 106 is in the closed position in order to form a uniform sealing engagement with the passage 104.

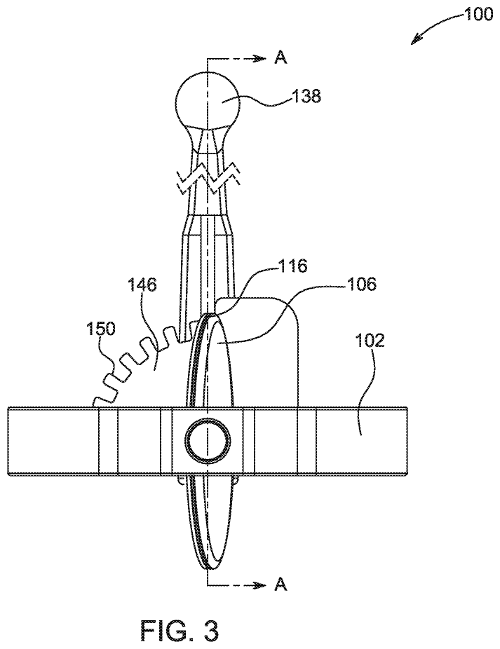

With reference to FIG. 4, the paddle member 106 is rotatable relative to the passage 104 of the valve body 102 about a rotation axis 122. The paddle member 106 is rotatably disposed within the passage 104 about the rotation axis 122 between an open position (shown in FIGS. 1 and 3-5) in which the paddle member 106 allows flow through the cylindrical passage 104 and a closed position (shown in FIGS. 6-9) in which the paddle member 106 blocks flow through the passage 104. In some embodiments or aspects, the paddle member 106 may be configured to rotate between the open position and the closed position (see FIGS. 3 and 8). When the paddle member 106 is in the closed position, the seal 116 and/or the circumferential surface 120 of the paddle member 106 engages the interior surface 114 of the passage 104 to form a sealing engagement with the passage 104 of the valve body 102.

With continued reference to FIG. 4, the paddle member 106 is rotatably connected to the valve body 102 via a drive shaft 124. In some embodiments or aspects, the paddle member 106 is rotatably connected to the valve body 102 via the drive shaft 124 and an idler shaft 126. The drive shaft 124 and the idler shaft 126 are positioned on opposing sides of the valve body 102, such as on opposite sides of the passage 104 of the valve body 102. The drive shaft 124 extends through a drive shaft aperture 128 in the valve body 102 and is received in a first shaft pocket 130 on the paddle member 106. Similarly, the idler shaft 126 extends through an idler shaft aperture 132 in the valve body 102 and is received in a second shaft pocket 134 on the paddle member 106 (shown in FIG. 5). The drive shaft 124 and the idler shaft 126 each include at least one seal 136 disposed thereon and configured to seal an engagement between the shafts 124, 126 and the valve body 102.

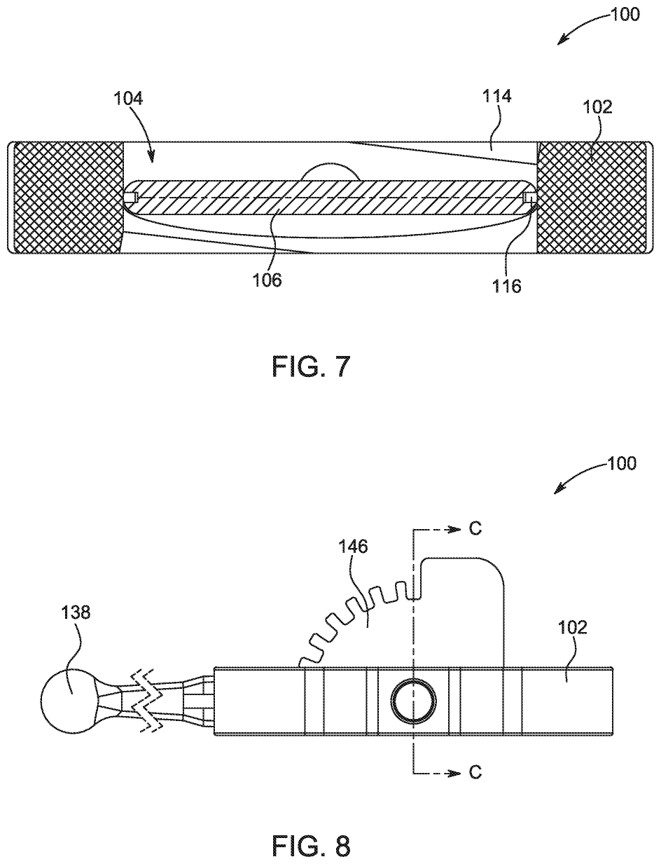

The drive shaft 124 and the idler shaft 126 are aligned such that the rotation axis 122 extends therethrough. The drive shaft 124 and the idler shaft 126 both rotate about the common rotation axis 122 of the paddle member 106. In some embodiments or aspects, the drive shaft 124 is operatively connected to an actuating member 107 such that the drive shaft 124 can be rotated with movement of at least a portion of the actuating member 107. With rotation of the drive shaft 124 about the rotation axis 122, the paddle member 106 is also rotated such that the paddle member 106 can be operated between the closed position (shown in FIG. 7) and the open positon (shown in FIG. 4).

As shown in FIG. 4, the rotation axis R of the paddle member 106 may be perpendicular to the longitudinal axis L of the passage 104. According to some non-limiting embodiments or aspects of the present disclosure, the paddle member 106 is configured to rotate 90° between the open and closed positions. It is to be appreciated that the paddle member 106 may be rotated along any angle between the open and closed positions known to be suitable to those having ordinary skill in the art.

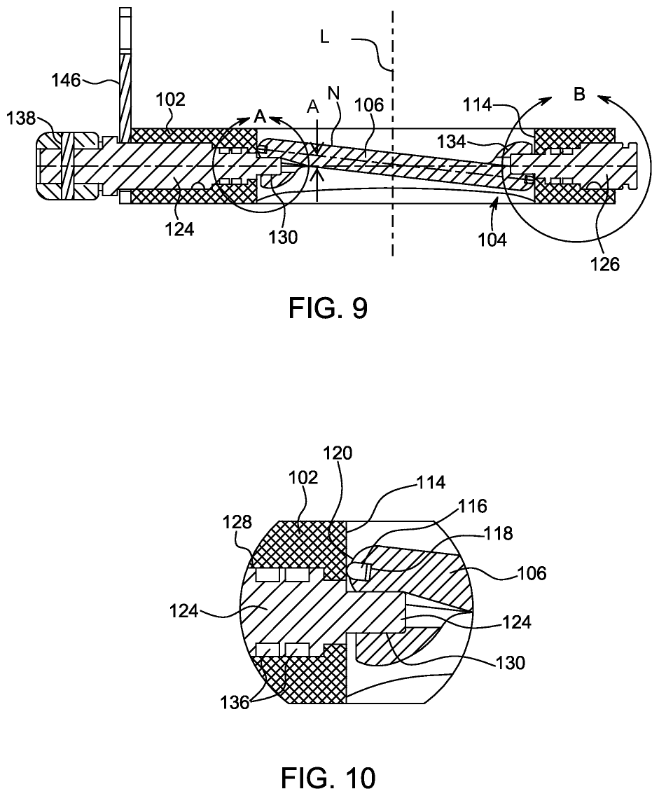

With reference to FIG. 5, the first shaft pocket 130 and the second shaft pocket 134 are provided on opposite sides of on the paddle member 106 and are offset relative to each other. Furthermore, the first shaft pocket 130 and the second shaft pocket 134 are offset relative to the rotation axis 122 of the paddle member 104. As shown in FIG. 9, due to the offset positioning of the first shaft pocket 130 and the second shaft pocket 134 of the paddle member 106 and the in-line positioning of the drive shaft 124 and the idler shaft 126, the paddle member 106 is rotatably connected within the passage 104 of the valve body 102 in a slanted or canted orientation. The face of the paddle member 106 defines a normal N that extends at a non-perpendicular angle A with respect to the longitudinal axis L of the passage 104 when the paddle member 106 is in the closed position.

The first shaft pocket 130 and the second shaft pocket 134 are defined in the paddle member 106 such that the seal 116 and/or a surface portion of the circumferential surface 120 of the paddle member 106 have a continuous circumferential contact with the interior surface 114 of the passage 104. Accordingly, the in-line rotation of the drive shaft 124 and the idler shaft 126 and the offset positioning of the first shaft pocket 130 and the second shaft pocket 134 creates the slanted or canted orientation of the paddle member 106 and allows for an uninterrupted seal or sealing surface to be provided around the entire circumference of the paddle member 106. This provides for effective sealing of the passage 104 around the entirety of the paddle member 106 when the paddle member 106 is in the closed position. The medial, elliptical bore assures the nearly 90 degree compression of the seal 116.

To provide additional effectiveness to the sealing engagement between the paddle member 106 and the passage 104, the passage 104 may be defined by a single, continuous interior surface 114 of the valve body 102 extending through the valve body 102 along the longitudinal axis L. As shown in FIGS. 9-10, the paddle member 106 may also be arranged such that first shaft pocket 130 receiving the drive shaft 124 is oriented toward the downstream side of the valve assembly 100 such that the seal 116 is positioned between the fluid flow and the drive shaft 124, which limits leakage of fluid into the drive shaft aperture 128 and around the drive shaft 124 and the actuating member 107. Leakage into the idler shaft aperture 132 is less of a concern because the idler shaft aperture 132 is closed either as a blind bore within the valve body 102 or by the closing member 160. This noted orientation sealing is equal for either the drive or idler in any installation without concern for which is front or back.

According to some non-limiting embodiments or aspects of the present disclosure, the angle A of the normal N of the paddle member 106 relative to the longitudinal axis L is relatively small. For example, the angle A of the normal N of the paddle member 106 may be between 5° and 25° , more particularly between 8° and 15° , more particularly between 9° and 12° , and more particularly approximately 10° . It is to be appreciated that the angle A may be any angle known to be suitable to those having ordinary skill in the art. Due to the low angle A of the inclination of the normal N of the paddle member 106, the valve body 102 can be provided with a relatively narrow profile or length along the longitudinal axis L. According to some embodiments or aspects of the present disclosure, the paddle member 106 has a circular shape. According to other embodiments or aspects of the present disclosure, the paddle member 106 has an elliptical shape to accommodate the angulation of the paddle member 106 with respect to the longitudinal axis L of the passage 102. It is to be appreciated that the paddle member 106 may have any shape configuration found to be suitable to those having ordinary skill in the art.

With reference to FIG. 2, the paddle valve assembly 100 may further include an actuating member 107 operatively connected to the drive shaft 124. The actuating member 107 is configured to be operated manually or by some mechanical, electro-mechanical, or pneumatic-mechanical system to rotate the drive shaft 124 and in turn move the paddle member 106 between the open and closed positions. The actuating member 107 includes a handle 138 connected to the drive shaft 124. In some embodiments or aspects, the handle 138 may have a key 140 configured to receive an end 142 of the drive shaft 124. The end 142 of the drive shaft 124 may be locked within the key 142 by a pin 144.

With continued reference to FIG. 2, the actuating member 107 further includes a metering plate 146. In some embodiments or aspects, the metering plate 146 may be connected to the valve body 102 via one or more fasteners 148. The metering plate 146 has a plurality of indexing slots 150 corresponding to a plurality of positions of the paddle member 106 between the open position and the closed position. The handle 138 has a movable tab 152 that is configured to be received in one of the plurality of indexing slots 150 to lock the position of the handle 138 relative to the metering plate 146. In this manner, the handle 146 can be locked in a desired position corresponding to a desired position of the paddle member 106 between the open position and the closed position. The handle 138 further may have a detent 154 that is configured to contact the metering plate 146. The detent 154 may have a spring 156 urging the detent 154 into contact with the metering plate 146.

The non-limiting embodiments or aspects of the present disclosure have been described in detail herein. However, it will be appreciated by those skilled in the art that various modifications and alternatives to the embodiments or aspects may be made without departing from the concepts disclosed in the foregoing description. Such modifications are to be considered as included within the following claims unless the claims, by their language, expressly state otherwise. Accordingly, the particular embodiments or aspects described in detail hereinabove are illustrative only and are not limiting as to the scope of the disclosure, which is to be given the full breadth of the appended claims and any and all equivalents thereof.

1. A paddle valve assembly comprising:
a valve body having an elliptical passage extending along a longitudinal axis;
a paddle member having a circular shape and rotatably disposed in the elliptical passage of the valve body; and
a drive shaft rotatably connecting the paddle member to the valve body, wherein the paddle member is rotatable within the elliptical passage about a rotation axis between an open position in which the paddle member allows flow through the elliptical passage and a closed position in which the paddle member blocks flow through the elliptical passage,
wherein the rotation axis of the paddle member is perpendicular to the longitudinal axis of the valve body, and
wherein, in the closed position, the paddle member is inclined relative to the elliptical passage at a non-perpendicular angle relative to the longitudinal axis of the valve body.

2. The paddle valve assembly according to claim 1, wherein the paddle member comprises a seal disposed about an entire circumference thereof, and wherein the seal forms a sealing engagement with the elliptical passage in the closed position of the paddle member.

3. The paddle valve assembly according to claim 2, wherein the sealing engagement between the seal and the elliptical passage is continuous about the entire circumference of the paddle member.

4. The paddle valve assembly according to claim 2, wherein the seal is disposed within a groove defined in a circumferential surface of the paddle member, and wherein the seal has a a non-circular cross-sectional shape.

5. (canceled)

6. The paddle valve assembly according to claim 1, wherein the paddle member is configured to rotate 90° between the open position and the closed position.

7. The paddle valve assembly according to claim 1, further comprising an idler shaft disposed in the valve body on an opposite side of the elliptical passage to the drive shaft, the idler shaft rotatably connecting the paddle member to the valve body.

8. The paddle valve assembly according to claim 7, wherein the drive shaft and the idler shaft are disposed in the valve body in line with each other and extend along the rotation axis of the paddle member.

9. The paddle valve assembly according to claim 7, wherein the paddle member further comprises a first shaft pocket and a second shaft pocket.

10. The paddle valve assembly according to claim 9, wherein the drive shaft is received in the first shaft pocket and the idler shaft is received in the second shaft pocket.

11. The paddle valve assembly according to claim 9, wherein the first shaft pocket and the second shaft pocket are offset with respect to the paddle member.

12. The paddle valve assembly according to claim 9, wherein the first shaft pocket and the second shaft pocket are in line with the rotation axis of the paddle member.

13. The paddle valve assembly according to claim 7, wherein the drive shaft and the idler shaft are disposed in respective apertures defined in the valve body intersecting with the elliptical passage,
wherein the drive shaft and the idler shaft have respective offset portions configured to be received within the first shaft pocket and the second shaft pocket of the paddle member,
wherein the drive shaft and the idler shaft each include at least one seal disposed thereon configured to seal an engagement between the shaft and the valve body.

14. The paddle valve assembly according to claim 1, further comprising an actuating member operatively connected to the drive shaft, the actuating member being configured to be operated to move the paddle member between the open position and the closed position.

15. The paddle valve assembly according to claim 14, wherein the actuating member comprises a handle connected to the drive shaft and a metering plate configured for selectively locking a position of the handle at one of a plurality of positions between a first position and a second position corresponding to the open position and the closed position of the paddle member.

16. A paddle valve assembly comprising:
a valve body having an elliptical passage, the elliptical passage extending along a longitudinal axis;
a paddle member having a circular shape and rotatably disposed in the elliptical passage of the valve body, wherein the paddle member has a circular or an elliptical shape;
a seal disposed about an entire circumference of the paddle member;
a drive shaft rotatably connecting the paddle member to the valve body; and
an actuating member operatively connected to the drive shaft, wherein the paddle member is rotatable via the actuating member within the elliptical passage about a rotation axis between an open position in which the paddle member allows flow through the elliptical passage and a closed position in which the paddle member blocks flow through the elliptical passage and the seal forms a sealing engagement with the elliptical passage in the closed position of the paddle member,
wherein the rotation axis of the paddle member is perpendicular to the longitudinal axis of the valve body, and
wherein, in the closed position, the paddle member is inclined relative to the elliptical passage at a non-perpendicular angle relative to the longitudinal axis of the valve body.

17. The paddle valve assembly according to claim 16, wherein the seal is disposed within a groove defined in a circumferential surface of the paddle member, and wherein the seal has a non-circular cross-sectional shape.

18. The paddle valve assembly according to claim 16, further comprising an idler shaft disposed in the valve body on an opposite side of the elliptical passage to the drive shaft, the idler shaft rotatably connecting the paddle member to the valve body.

19. The paddle valve assembly according to claim 16, wherein the actuating member comprises a handle connected to the drive shaft and a metering plate configured for selectively locking a position of the handle at one of a plurality of positions between a first position and a second position corresponding to the open position and the closed position of the paddle member.

20. A paddle valve assembly, comprising:
a valve body having an elliptical passage, the elliptical passage extending along a longitudinal axis;
an elliptical paddle member rotatably disposed in the elliptical passage of the valve body, the elliptical paddle member comprising a seal having a non-circular cross-sectional shape and disposed about an entire circumference thereof, a first shaft pocket, and a second shaft pocket;
and
a drive shaft and an idler shaft disposed in the valve body on opposite sides of the elliptical passage, the drive shaft and the idler shaft rotatably connecting the elliptical paddle member to the valve body, the drive shaft being received in the first shaft pocket of the elliptical paddle member and the idler shaft being received in the second shaft pocket of the elliptical paddle member,
wherein the elliptical paddle member is rotatable within the elliptical passage about a rotation axis between an open position in which the elliptical paddle member allows flow through the elliptical passage and a closed position in which the elliptical paddle member blocks flow through the elliptical passage and the seal forms a sealing engagement with the elliptical passage of the valve body, the rotation axis of the elliptical paddle member being perpendicular to the longitudinal axis of the valve body,
wherein the drive shaft and the idler shaft are disposed in the valve body in line with each other and extend along the rotation axis of the elliptical paddle member,
wherein the first shaft pocket and the second shaft pocket of the elliptical paddle member are offset with respect to the paddle member, and
wherein the elliptical paddle member defines a normal that extends at an angle with respect to the longitudinal axis of the elliptical passage when the elliptical paddle member is in the closed position, and
wherein the first shaft pocket and the second shaft pocket are defined in the elliptical paddle member such that the seal extending about the entire circumference of the elliptical paddle member is uninterrupted and the sealing engagement between the seal and the elliptical passage of the valve body is continuous about the entire circumference of the elliptical
